(19) United States
(12) Patent Application Publication
(10) Pub. No.: US 2026/0109234 A1
(43) Pub. Date: Apr. 23, 2026

(54) ELECTRIFIED VEHICLE

(71) Applicant: TOYOTA JIDOSHA KABUSHIKI KAISHA, Toyota-shi (JP)

(72) Inventors: Hiroshi Morita, Susono-shi (JP); Hiroaki Toyoda, Mishima-shi (JP); Kazuma Fujiwara, Kobe-shi (JP)

(73) Assignee: TOYOTA JIDOSHA KABUSHIKI KAISHA, Toyota-shi (JP)

(21) Appl. No.: 19/250,384

(22) Filed: Jun. 26, 2025

(30) Foreign Application Priority Data
Oct. 18, 2024 (JP) 2024-184296

(51) Int. Cl. B60L 3/00; B60L 50/60; H02M 7/5387

(52) U.S. Cl. CPC B60L 3/003; B60L 3/0092; B60L 50/60; H02M 7/5387; B60L 2210/42; B60L 2240/526

(57) ABSTRACT

The electrified vehicle includes a battery system including first and second batteries, a series line, a parallel line, and first to fourth relays, a motor, and a power conversion device including first and second inverter units and first and second changeover switches. In a case where the abnormality occurs in at least one of the first upper arms of the respective phases of the first inverter unit, the electrified vehicle turns on the second relay, turns off the first, third, and fourth relays, turns off the first and second changeover switches, sets the second end side of the three-phase open winding to a neutral potential by the second inverter unit, and drives the motor by switching the intermediate potential switches of the respective phases and the first lower arms of the respective phases.

### CROSS-REFERENCE TO RELATED APPLICATION

This application claims priority to Japanese Patent Application No. 2024-184296 filed on Oct. 18, 2024. The disclosure of the above-identified application, including the specification, drawings, and claims, is incorporated by reference herein in its entirety.

### BACKGROUND

### 1. Technical Field

The present disclosure relates to an electrified vehicle.

### 2. Description of Related Art

In the related art, an electrified vehicle including a battery, a motor for traveling, a first inverter unit, a second inverter unit, and first and second changeover switches has been proposed (for example, see Japanese Unexamined Patent Application Publication No. 2018-14829 (JP 2018-14829 A)). The motor for traveling includes a three-phase open winding. The first inverter unit is connected to a positive electrode line and a negative electrode line to which the battery is connected, and is connected to a first end side of the three-phase open winding. The second inverter unit is connected to the positive electrode line and the negative electrode line on an opposite side of the first inverter unit from the battery, and is connected to a second end side of the three-phase open winding. The first and second changeover switches are provided between the first and second inverter units on the positive electrode line and the negative electrode line.

### SUMMARY

In such an electrified vehicle, one issue is how to perform limp-home traveling when an abnormality occurs in the first inverter unit or the like. A main object of the electrified vehicle according to the present disclosure is to enable limp-home traveling when an abnormality occurs in a first inverter unit or the like.

The electrified vehicle of the present disclosure adopts the following measures to achieve the main object described above. Each of the first, second, and third electrified vehicles of the present disclosure includes:
a battery system including a first battery in which a first positive electrode terminal is connected to a positive electrode line, a second battery in which a second negative electrode terminal is connected to a negative electrode line, a first relay provided on the positive electrode line, a second relay provided on the negative electrode line, a third relay provided on a series line that connects a first negative electrode terminal of the first battery and a second positive electrode terminal of the second battery, and a fourth relay provided on a parallel line that connects the series line on a side that is closer to the first battery than the third relay and the negative electrode line on a side that is farther from the second battery than the second relay;
a motor for traveling including a three-phase open winding;
a power conversion device including a first inverter unit connected to the positive electrode line and the negative electrode line and connected to a first end side of the three-phase open winding, a second inverter unit connected to the positive electrode line and the negative electrode line on a side farther from the battery system than the first inverter unit and connected to a second end side of the three-phase open winding, and a first changeover switch and a second changeover switch that are provided between the first inverter unit and the second inverter unit on the positive electrode line and the negative electrode line, respectively; and
a control device, in which:
the first inverter unit includes a first upper arm and a first lower arm of each phase that are connected in series with each other with respect to the positive electrode line and the negative electrode line, with a connection point between the first upper arm and the first lower arm being connected to the first end side of the three-phase open winding for the phase, a first capacitor and a second capacitor that are connected in series with each other with respect to the positive electrode line and the negative electrode line, with a connection point between the first capacitor and the second capacitor being connected to the series line on a side that is closer to the second battery than the third relay, and an intermediate potential switch of the phase that is provided on an intermediate potential line of the phase that connects the connection point between the first upper arm and the first lower arm of the phase and the connection point between the first capacitor and the second capacitor; and
the second inverter unit includes a second upper arm and a second lower arm of the phase that are connected in series with each other with respect to the positive electrode line and the negative electrode line, with a connection point between the second upper arm and the second lower arm being connected to the second end side of the three-phase open winding for the phase.

In the first electrified vehicle of the present disclosure, the control device is configured to,
when an abnormality occurs in at least one of the first upper arms of the respective phases, turn on the second relay, turn off the first relay, the third relay, and the fourth relay, turn off the first changeover switch and the second changeover switch, create a neutral point on the second end side of the three-phase open winding by the second inverter unit, and perform switching of the intermediate potential switches of the respective phases and the first lower arms of the respective phases, to drive the motor, and
when an abnormality occurs in at least one of the first lower arms of the respective phases, turn on the first relay and the third relay, turn off the second relay and the fourth relay, turn off the first changeover switch and the second changeover switch, create the neutral point on the second end side of the three-phase open winding by the second inverter unit, and perform switching of the first upper arms of the respective phases and the intermediate potential switches of the respective phases, to drive the motor.

In this manner, when an abnormality occurs in at least one of the first upper arms of the respective phases or in at least one of the first lower arms of the respective phases, limp-home traveling can be performed.

In the second electrified vehicle of the present disclosure, the control device is configured to, when an open-circuit abnormality occurs in at least one of the first upper arms and the first lower arms of the respective phases, or when a short-circuit abnormality occurs in at least one of the intermediate potential switches of the respective phases, turn on the first relay and the fourth relay, turn off the second relay and the third relay, turn on the first changeover switch and the second changeover switch, turn off the first upper arms and the first lower arms of the respective phases, turn on the intermediate potential switches of the respective phases, and perform switching of the second inverter unit, to drive the motor. In this manner, when an open-circuit abnormality occurs in at least one of the first upper arms and the first lower arms of the respective phases, or when a short-circuit abnormality occurs in at least one of the intermediate potential switches of the respective phases, limp-home traveling can be performed.

In the third electrified vehicle of the present disclosure, the control device is configured to, when an open-circuit abnormality occurs in at least one of the first upper arms of the respective phases, or when a short-circuit abnormality occurs in at least one of the first lower arms of the respective phases, turn on the first relay, the second relay, and the third relay, turn off the fourth relay, turn on the first changeover switch and the second changeover switch, turn off the first upper arms of the respective phases, turn on the first lower arms of the respective phases, turn off the intermediate potential switches of the respective phases, and perform switching of the second inverter unit, to drive the motor.

In this manner, when an open-circuit abnormality occurs in at least one of the first upper arms of the respective phases or when a short-circuit abnormality occurs in at least one of the first lower arms of the respective phases, limp-home traveling can be performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a schematic configuration of a battery electric vehicle 10 of an embodiment of the present disclosure;

FIG. 2 is an explanatory diagram showing an example of limp-home traveling when an abnormality occurs in the transistor T11;

FIG. 3 is an explanatory diagram showing an example of limp-home traveling when an abnormality occurs in the transistor T14;

FIG. 4 is an explanatory diagram showing an example of limp-home traveling when an open-circuit abnormality occurs in the transistor T11; and

FIG. 5 is an explanatory diagram showing an example of limp-home traveling when a short-circuit abnormality occurs in the transistor T14.

### DETAILED DESCRIPTION OF EMBODIMENTS

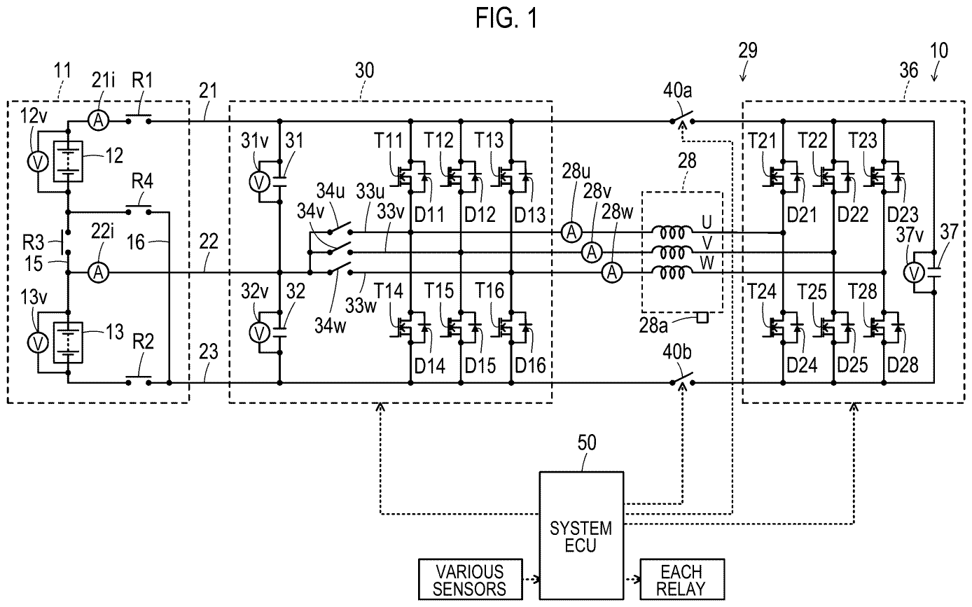

An embodiment for carrying out the present disclosure will be described with reference to the drawings. FIG. 1 is a schematic configuration diagram showing a schematic configuration of a battery electric vehicle 10 of an embodiment of the present disclosure. As shown in the drawing, the battery electric vehicle 10 of the embodiment includes a battery system 11, a motor 28, a power conversion device 29, and an electronic control unit (hereinafter, referred to as “ECU”) 50 (control device).

The battery system 11 includes first and second batteries 12, 13, and first to fourth relays R1 to R4. The first and second batteries 12, 13 are respectively configured as, for example, a lithium ion secondary battery or a nickel-hydrogen secondary battery having a rated voltage of about a first voltage Vs1 (for example, several hundred V). In the embodiment, the first and second batteries 12, 13 having the same specifications are used.

A first positive electrode terminal of the first battery 12 is connected to the positive electrode line 21. A second negative electrode terminal of the second battery 13 is connected to a negative electrode line 23. The first relay R1 is provided on the positive electrode line 21. The second relay R2 is provided on the negative electrode line 23. The third relay R3 is provided on a series line 15 that connects the first negative electrode terminal of the first battery 12 and the second positive electrode terminal of the second battery 13. The fourth relay R4 is provided on a parallel line 16 that connects a side of the series line 15 that is closer to the first battery 12 than the third relay R3 and a side of the negative electrode line 23 that is farther from the second battery 13 than the second relay.

The motor 28 is configured as a three-phase alternating current motor, and includes a rotor in which a permanent magnet is embedded in a rotor core and a stator in which coils (open windings) of three phases (U phase, V phase, W phase) are wound around a stator core. The rotor is connected to a drive shaft that is coupled to drive wheels via a differential gear.

The power conversion device 29 includes a first inverter unit 30, a second inverter unit 36, and first and second changeover switches 40a, 40b. The first inverter unit 30 is connected to the positive electrode line 21, the intermediate potential line 22, and the negative electrode line 23, and is connected to a first end side of the coils of the three phases of the motor 28. The first inverter unit 30 includes a T-type three-level inverter. Specifically, the first inverter unit 30 includes six transistors T11 to T16, diodes D11 to D16, two capacitors 31, 32, intermediate potential lines 33u, 33v, 33w of three phases, and intermediate potential switches 34u, 34v, 34w of three phases. The six diodes D11 to D16 are connected in parallel to the six transistors T11 to T16, respectively. In addition, the three phases are U phase, V phase, and W phase. The transistors T11 to T16 each use, for example, as a MOSFET or an IGBT. The transistors T11 to T16 are disposed in pairs of two, so that the two transistors in each pair disposed on the source side and the sink side with respect to the positive electrode line 21 and the negative electrode line 23, respectively. The connection point between the transistors T11, T14, the connection point between the transistors T12, T15, and the connection point between the transistors T13, T16 are connected to the first end side of the U-phase, V-phase, and W-phase coils of the motor 28, respectively. The transistors T11 to T13 may be referred to as “first upper arms”, and the transistors T14 to T16 may be referred to as “first lower arms”. The capacitors 31, 32 are connected in series with each other in this order with respect to the positive electrode line 21 and the negative electrode line 23. The capacitors 31, 32 having the same specifications are used. The connection point between the capacitors 31, 32 is connected to a side of the series line 15 that is closer to the second battery 13 than the third relay R3 via the intermediate potential line 22. The intermediate potential lines 33u, 33v, 33w of three phases connect the connection point between the transistors T11, 14, the connection point between the transistors T12, T15, the connection point between the transistors T13, T16, and the connection point between the capacitors 31, 32, respectively. The intermediate potential switches 34u, 34v, 34w of three phases are provided in the intermediate potential lines 33u, 33v, 33w of three phases, respectively. The intermediate potential switches 34u, 34v, 34w of the three phases respectively use, for example, a semiconductor switch, specifically, a wide bandgap semiconductor switch using gallium nitride (GaN) or silicon carbide (SiC). The intermediate potential switch 26u may be configured, for example, using two sets each including a transistor and a diode connected in parallel to the transistor, with the diodes connected in series with each other in opposite directions. The intermediate potential switches 26v, 26w are also the same.

The second inverter unit 36 is connected to the positive electrode line 21 and the negative electrode line 23 on a side farther from the battery system 11 than the first inverter unit 30. The second inverter unit 36 includes a two-level inverter, specifically, six transistors T21 to T26, six diodes D21 to D26 that are respectively connected in parallel to the transistors T21 to T26, and a capacitor 37. The transistors T21 to T26 use, for example, a MOSFET or an IGBT. The transistors T21 to T26 are disposed in pairs of two, so that the two transistors in each pair disposed on the source side and the sink side with respect to the positive electrode line 21 and the negative electrode line 23, respectively. The connection point between the transistors T21, T24, the connection point between the transistors T22, T25, and the connection point between the transistors T23, T26 are connected to the second end side of the U-phase, V-phase, and W-phase coils of the motor 28, respectively. The transistors T21 to T23 may be referred to as “second upper arms”, and the transistors T24 to T26 may be referred to as “second lower arms”. The capacitor 37 is connected to the positive electrode line 21 and the negative electrode line 23.

The first and second changeover switches 40a, 40b are provided between the first and second inverter units 30, 36 on the positive electrode line 21 and the negative electrode line 23, respectively. The first and second changeover switches 40a, 40b use, for example, semiconductor switches. The first changeover switch 40a may be configured, for example, using two sets each including a transistor and a diode connected in parallel to the transistor, with the diodes connected in series with each other in opposite directions. The second changeover switch 40b is also the same.

The ECU 50 includes a microcomputer having a CPU, a ROM, a RAM, a flash memory, an input/output port, and a communication port, or various drive circuits and various logic ICs. The ECU 50 receives signals from various sensors. For example, the ECU 50 receives the voltage Vb1, the voltage Vb2, the current Ip1, and the current Ip2. The voltage Vb1 is the voltage of the first battery 12 from the voltage sensor 12v. The voltage Vb2 is the voltage of the second battery 13 from the voltage sensor 13v. The current Ip1 is a current of the positive electrode line 21 from the current sensor 21i. The current Ip2 is a current of the intermediate potential line 22 from the current sensor 22i. The ECU 50 also receives a rotational position θm of the rotor of the motor 28 from the rotational position sensor 28a, and phase currents Iu, Iv, Iw of the motor 28 from current sensors 28u, 28v, 28w. The ECU 50 also receives the voltage Vc1 of the capacitor 31 from the voltage sensor 31v, the voltage Vc2 of the capacitor 32 from the voltage sensor 32v, and the voltage Vc3 of the capacitor 37 from the voltage sensor 37v. The ECU 50 also receives the on/off signal, the shift position SP, the accelerator operation amount Acc, the brake pedal position BP, and the vehicle speed V. The on/off signal is an input from the power switch. The shift position SP is an operational position of a shift lever and is an input from a shift position sensor. The accelerator operation amount Acc is an amount of depression of an accelerator pedal and is an input from an accelerator pedal position sensor. The brake pedal position BP is an amount of depression of the brake pedal and is an input from a brake pedal position sensor. The vehicle speed V is an input from a vehicle speed sensor.

The ECU 50 calculates the states of charge SOC1, SOC2 of the first and second batteries 12, 13, and the electrical angle θe and the rotational speed Nm of the motor 28. The states of charge SOC1, SOC2 of the first and second batteries 12, 13 are calculated based on the states of the first to fourth relays R1 to R4 and the currents Ip1, Ip2 of the positive electrode line 21 and the intermediate potential line 22. The electrical angle θe and the rotational speed Nm of the motor 28 are calculated based on the rotational position θm of the rotor of the motor 28. The ECU 50 outputs various control signals. For example, the ECU 50 outputs a control signal to the battery system 11, a control signal to the first inverter unit 30, a control signal to the second inverter unit 36, and a control signal to the first and second changeover switches 40a, 40b. The battery system 11 includes first to fourth relays R1 to R4. The first inverter unit 30 includes transistors T11 to T16 and intermediate potential switches 34u, 34v, 34w of three phases. The second inverter unit 36 includes transistors T21 to T26.

In the battery electric vehicle 10 according to the embodiment, the ECU 50 sets the request torque Td* requested for traveling based on the accelerator operation amount Acc and the vehicle speed V. The ECU 50 sets the torque command Tm* of the motor 28 such that the vehicle travels by the set request torque Td*. Further, the ECU 50 basically selects and executes one of the two-level H drive mode, the two-level Y drive mode, and the three-level Y drive mode based on the set torque command Tm* to perform traveling. Here, the H drive refers to driving the motor 28 by switching the first and second inverter units 30, 36. The Y drive refers to setting the side closer to the second inverter unit 36 (the second end side of the coils of the three phases) to a neutral potential than the motor 28 and driving the motor 28 by switching the first inverter unit 30. In any of the two-level H drive mode, the two-level Y drive mode, and the three-level Y drive mode, the first, second, and third relays R1, R2, R3 are turned on and the fourth relay R4 is turned off in the battery system 11. That is, the first and second batteries 12, 13 are connected in series.

A two-level H drive mode will be described. In this mode, the first and second changeover switches 40a, 40b are turned on. In addition, for the first and second inverter units 30, 36, the intermediate potential switches 34u, 34v, 34w of the three phases are turned off, and the transistors T11 to T16, T21 to T26 are switched and driven. In this way, the potential of the first end side and the second end side of the motor 28 is switched between two levels (the potential of the positive electrode line 21 and the potential of the negative electrode line 23).

A two-level Y drive mode will be described. In this mode, the first and second changeover switches 40a, 40b are turned off. In addition, for the second inverter unit 36, one of the second upper arms (transistors T21 to T23) of the three phases and one of the second lower arms (transistors T24 to T26) of the three phases are turned on, and the other is turned off. As a result, the side closer to the second inverter unit 36 (the second end side of the coils of the three phases) than the motor 28 is set to a neutral potential. Since the first and second changeover switches 40a, 40b are turned off, all of the transistors T21 to T26 may be turned on. Further, for the first inverter unit 30, the intermediate potential switches 34u, 34v, 34w of the three phases are turned off, and the transistors T11 to T16 are switched and driven. In this way, the potential of the first end side of the motor 28 is switched between two levels (the potential of the positive electrode line 21 and the potential of the negative electrode line 23).

A three-level Y drive mode will be described. The mode is different from the two-level Y drive mode in that the intermediate potential switches 34u, 34v, 34w of the three phases and the transistors T11 to T16 are switched and driven in the first inverter unit 30. In this way, the potential of the first end side of the motor 28 is switched to three levels (the potential of the positive electrode line 21, the potential of the connection point between the capacitors 31, 32, and the potential of the negative electrode line 23).

Next, the operation of the battery electric vehicle 10 according to the embodiment, particularly, the operation when the abnormality occurs in the power conversion device 29 and limp-home mode traveling is performed will be described. First, a case where an abnormality occurs in the first and second changeover switches 40a, 40b will be described. When the open-circuit abnormality occurs in at least one of the first and second changeover switches 40a, 40b, the first and second changeover switches 40a, 40b are turned off. As a result, limp-home traveling can be performed by executing the two-level Y drive mode or the three-level Y drive mode described above. When the short-circuit abnormality occurs in at least one of the first and second changeover switches 40a, 40b, the first and second changeover switches 40a, 40b are turned on. As a result, limp-home traveling can be performed by executing the two-level H drive mode.

Next, a case where an abnormality occurs in the second inverter unit 36 will be described. There may be cases where a short-circuit abnormality occurs in at least one of the second upper arms (transistors T21 to T23) of the three phases of the second inverter unit 36, or an open-circuit abnormality occurs in at least one of the second lower arms (transistors T24 to T26) of the three phases of the second inverter unit 36. In these cases, the first and second changeover switches 40a, 40b are turned off, the second upper arms of the three phases are turned on, and the second lower arms of the three phases are turned off. In addition, there may be cases where an open-circuit abnormality occurs in at least one of the second upper arms of the three phases or a short-circuit abnormality occurs in at least one of the second lower arms of the three phases. In these cases, the first and second changeover switches 40a, 40b are turned off, the second upper arms of the three phases are turned off, and the second lower arms of the three phases are turned on. From the above, limp-home traveling can be performed by executing the two-level Y drive mode or the three-level Y drive mode.

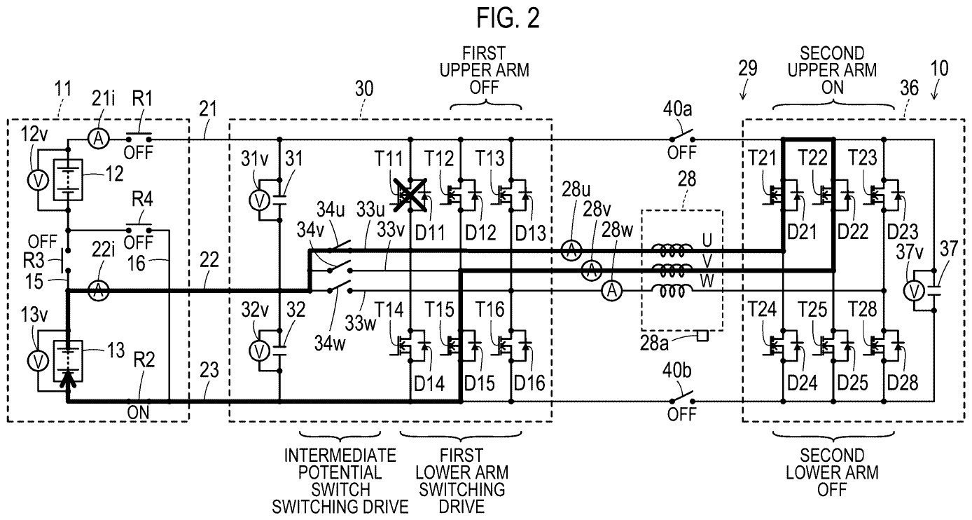

Next, a case where an abnormality occurs in the first inverter unit 30 will be described. First, a case where an abnormality (short-circuit abnormality or open-circuit abnormality) occurs in at least one of the first upper arms (transistors T11 to T13) of the three phases of the first inverter unit 30 will be described. FIG. 2 is an explanatory diagram showing an example of limp-home traveling when an abnormality occurs in the transistor T11. As shown in the drawing, when an abnormality occurs in the transistor T11, the first, third, and fourth relays R1, R3, R4 are turned off, and the second relay R2 is turned on. As a result, solely the second battery 13 among the first and second batteries 12, 13 is connected to the side of the first inverter unit 30, and the first upper arms (transistors T11 to T13) of the three phases that are connected to the positive electrode line 21 are disconnected from the battery system 11 (first battery 12). Further, as in the two-level Y drive mode or the three-level Y drive mode, the first and second changeover switches 40a, 40b are turned off, and the side closer to the second inverter unit 36 than the motor 28 is set to a neutral potential. In FIG. 2, the second upper arms (transistors T21 to T23) of three phases are turned on, and the second lower arms (transistors T24 to T26) of three phases are turned off. Further, the transistors T12, T13 are turned off. Then, the intermediate potential switches 34u, 34v, 34w of the three phases and the transistors T14 to T16 are switched and driven. As a result, the intermediate potential switches 34u, 34v, 34w of the three phases function as substitutes for the first upper arms (transistors T11 to T13) of the three phases, so that the first inverter unit 30 can be operated as a two-level inverter. In this way, limp-home traveling can be performed using the electric power from the second battery 13. Here, a case where the abnormality occurs in the transistor T11 has been described, but the same consideration can be applied when the abnormality occurs in any of the transistors T12, T13, or the abnormality occurs in a plurality of the transistors T11 to T13.

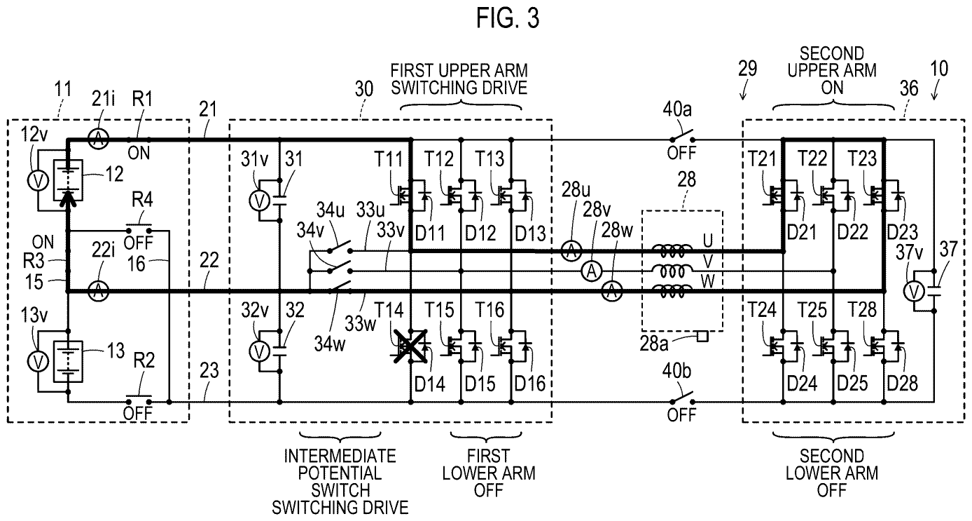

Next, a case where an abnormality (short-circuit abnormality or open-circuit abnormality) occurs in at least one of the first lower arms (transistors T14 to T16) of the three phases of the first inverter unit 30 will be described. FIG. 3 is an explanatory diagram showing an example of limp-home traveling when an abnormality occurs in the transistor T14. As shown in the drawing, when a short-circuit abnormality occurs in the transistor T14, the second and fourth relays R2, R4 are turned off and the first and third relays R1, R3 are turned on. As a result, solely the first battery 12 among the first and second batteries 12, 13 is connected to the side of the first inverter unit 30, and the first lower arms (transistors T14 to T16) of the three phases connected to the negative electrode line 23 are disconnected from the battery system 11 (the second battery 13). Further, as in the two-level Y drive mode or the three-level Y drive mode, the first and second changeover switches 40a, 40b are turned off, and the side closer to the second inverter unit 36 than the motor 28 is set to a neutral potential. In FIG. 3, the second upper arms (transistors T21 to T23) of three phases are turned on, and the second lower arms (transistors T24 to T26) of three phases are turned off. Further, the transistors T15, T16 are turned off. Then, the intermediate potential switches 34u, 34v, 34w of the three phases and the transistors T11 to T13 are switched and driven. As a result, the intermediate potential switches 34u, 34v, 34w of the three phases function as substitutes for the first lower arms (transistors T14 to T16) of the three phases, so that the first inverter unit 30 can be operated as a two-level inverter. In this way, limp-home traveling can be performed using the electric power from the first battery 12. Here, a case where the abnormality occurs in the transistor T14 has been described, but the same consideration can be applied when the abnormality occurs in any of the transistors T15, T16, or the abnormality occurs in a plurality of the transistors T14 to T16.

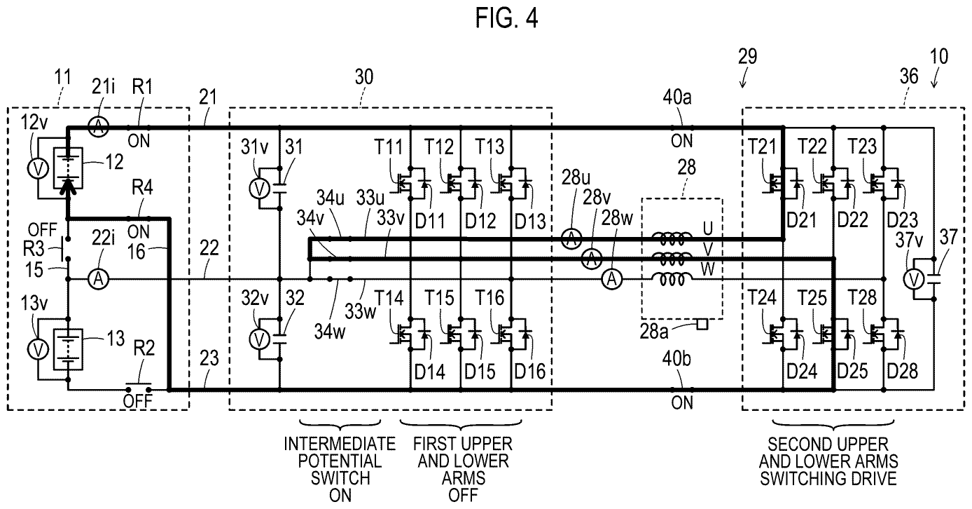

Next, a case where a short-circuit abnormality occurs in at least one of the intermediate potential switches 34u, 34v, 34w of the three phases will be described. FIG. 4 is an explanatory diagram showing an example of limp-home traveling when a short-circuit abnormality occurs in at least one of the intermediate potential switches 34u, 34v, 34w of the three phases. As shown in the drawing, a short-circuit abnormality may occur in at least one of the intermediate potential switches 34u, 34v, 34w of the three phases. In this case, the first and fourth relays R1, R4 are turned on, the second and third relays R2, R3 are turned off, the transistors T12 to T16 are turned off, and the intermediate potential switches 34u, 34v, 34w of the three phases are turned on. As a result, the side closer to the first inverter unit 30 than the motor 28 is set to a neutral potential. In addition, the first and second changeover switches 40a, 40b are turned on. Further, the transistors T21 to T26 of the second inverter unit 36 are switched and driven. In this way, limp-home traveling can be performed using the electric power from the first battery 12. Instead of turning off the second and fourth relays R2, R4 and turning on the first and third relays R1, R3, the fourth relay R4 may be turned off and the first, second, and third relays R1, R2, R3 may be turned on.

In addition, a case where the open-circuit abnormality occurs in at least one of the intermediate potential switches 34u, 34v, 34w of the three phases will be described. In this case, the intermediate potential switches 34u, 34v, 34w of the three phases are turned off. As a result, limp-home traveling can be performed by executing the two-level H drive mode or the two-level Y drive mode.

An abnormality (short-circuit abnormality, open-circuit abnormality) may occur in at least one of the first upper arms (transistors T11 to T13) of the three phases of the first inverter unit 30. In this case, in the above-described embodiment, the first, third, and fourth relays R1, R3, R4 are turned off, and the second relay R2 is turned on. Further, the first and second changeover switches 40a, 40b are turned off. Further, the side closer to the second inverter unit 36 than the motor 28 is set to a neutral potential. Furthermore, the intermediate potential switches 34u, 34v, 34w of the three phases and the transistors T14 to T16 are switched and driven (see FIG. 2). In addition, an abnormality (short-circuit abnormality, open-circuit abnormality) may occur in at least one of the first lower arms (transistors T14 to T16) of the three phases of the first inverter unit 30. In this case, the second and fourth relays R2, R4 are turned off, and the first and third relays R1, R3 are turned on. Further, the first and second changeover switches 40a, 40b are turned off. Further, the side closer to the second inverter unit 36 than the motor 28 is set to a neutral potential. Furthermore, the intermediate potential switches 34u, 34v, 34w of the three phases and the transistors T11 to T13 are configured to be switched and driven (see FIG. 3). However, when the open-circuit abnormality occurs in at least one of the first upper arms of the three phases and the first lower arms of the three phases, the control may be performed in the same manner as when the short-circuit abnormality occurs in at least one of the intermediate potential switches 34u, 34v, 34w of the three phases (see FIG. 4).

An abnormality (short-circuit abnormality, open-circuit abnormality) may occur in at least one of first lower arms (transistors T14 to T16) of the three phases of the first inverter unit 30. In this case, in the above-described embodiment, the second and fourth relays R2, R4 are turned off, and the first and third relays R1, R3 are turned on. Further, the first and second changeover switches 40a, 40b are turned off. Further, the side closer to the second inverter unit 36 than the motor 28 is set to a neutral potential. Furthermore, the intermediate potential switches 34u, 34v, 34w of the three phases and the transistors T11 to T13 are switched and driven (see FIG. 3). However, when a short-circuit abnormality occurs in the first lower arms of the three phases of the first inverter unit 30, the following control may be performed.

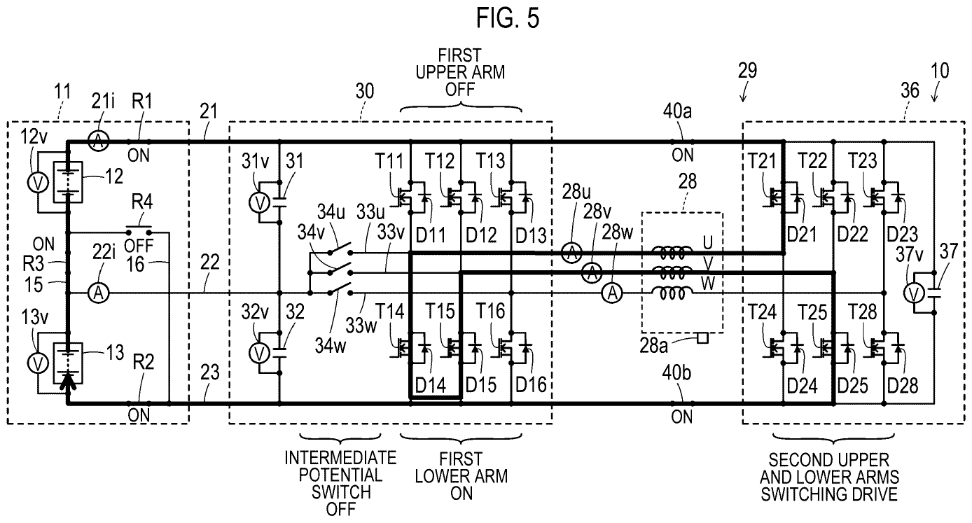

FIG. 5 is an explanatory diagram showing an example of limp-home traveling when a short-circuit abnormality occurs in the transistor T14. As shown in the drawing, when a short-circuit abnormality occurs in the transistor T14, the transistors T15, 16 are turned on, and the transistors T11 to T13 are turned off. In addition, the first, second, and third relays R1, R2, R3 are turned on, the fourth relay R4 is turned off, and the intermediate potential switches 34u, 34v, 34w of the three phases are turned off. From these, the side closer to the first inverter unit 30 than the motor 28 is set to a neutral potential. However, the neutral point is connected to the negative electrode line 23. Then, the transistors T21 to T26 of the second inverter unit 36 are switched and driven. In this way, limp-home traveling can be performed using the electric power from the first and second batteries 12, 13. Here, the case where the short-circuit abnormality occurs in the transistor T14 has been described, but the same consideration can be applied when the short-circuit abnormality occurs in any of the transistors T15, T16, and when the short-circuit abnormality occurs in a plurality of the transistors T14 to T16. In addition to or as alternative to these, the same consideration can be applied when the open-circuit abnormality occurs in at least one of the transistors T11 to T13.

Although the embodiment for implementing the above-described disclosure has been described, the above-described disclosure is not limited to the embodiment, and can be implemented in various forms within the scope of the spirit of the above-described disclosure.

The present disclosure can be used in the manufacturing industry of electrified vehicles.

What is claimed is:

1. An electrified vehicle comprising:
a battery system including a first battery in which a first positive electrode terminal is connected to a positive electrode line, a second battery in which a second negative electrode terminal is connected to a negative electrode line, a first relay provided on the positive electrode line, a second relay provided on the negative electrode line, a third relay provided on a series line that connects a first negative electrode terminal of the first battery and a second positive electrode terminal of the second battery, and a fourth relay provided on a parallel line that connects the series line on a side that is closer to the first battery than the third relay and the negative electrode line on a side that is farther from the second battery than the second relay;
a motor for traveling including a three-phase open winding;
a power conversion device including a first inverter unit connected to the positive electrode line and the negative electrode line and connected to a first end side of the three-phase open winding, a second inverter unit connected to the positive electrode line and the negative electrode line on a side farther from the battery system than the first inverter unit and connected to a second end side of the three-phase open winding, and a first changeover switch and a second changeover switch that are provided between the first inverter unit and the second inverter unit on the positive electrode line and the negative electrode line, respectively; and
a control device, wherein:
the first inverter unit includes a first upper arm and a first lower arm of each phase that are connected in series with each other with respect to the positive electrode line and the negative electrode line, with a connection point between the first upper arm and the first lower arm being connected to the first end side of the three-phase open winding for the phase, a first capacitor and a second capacitor that are connected in series with each other with respect to the positive electrode line and the negative electrode line, with a connection point between the first capacitor and the second capacitor being connected to the series line on a side that is closer to the second battery than the third relay, and an intermediate potential switch of the phase that is provided on an intermediate potential line of the phase that connects the connection point between the first upper arm and the first lower arm of the phase and the connection point between the first capacitor and the second capacitor;
the second inverter unit includes a second upper arm and a second lower arm of the phase that are connected in series with each other with respect to the positive electrode line and the negative electrode line, with a connection point between the second upper arm and the second lower arm being connected to the second end side of the three-phase open winding for the phase; and
the control device is configured to,
when an abnormality occurs in at least one of the first upper arms of the respective phases, turn on the second relay, turn off the first relay, the third relay, and the fourth relay, turn off the first changeover switch and the second changeover switch, create a neutral point on the second end side of the three-phase open winding by the second inverter unit, and perform switching of the intermediate potential switches of the respective phases and the first lower arms of the respective phases, to drive the motor, and
when an abnormality occurs in at least one of the first lower arms of the respective phases, turn on the first relay and the third relay, turn off the second relay and the fourth relay, turn off the first changeover switch and the second changeover switch, create the neutral point on the second end side of the three-phase open winding by the second inverter unit, and perform switching of the first upper arms of the respective phases and the intermediate potential switches of the respective phases, to drive the motor.

2. An electrified vehicle comprising:
a battery system including a first battery in which a first positive electrode terminal is connected to a positive electrode line, a second battery in which a second negative electrode terminal is connected to a negative electrode line, a first relay provided on the positive electrode line, a second relay provided on the negative electrode line, a third relay provided on a series line that connects a first negative electrode terminal of the first battery and a second positive electrode terminal of the second battery, and a fourth relay provided on a parallel line that connects the series line on a side that is closer to the first battery than the third relay and the negative electrode line on a side that is farther from the second battery than the second relay;
a motor for traveling including a three-phase open winding;
a power conversion device including a first inverter unit connected to the positive electrode line and the negative electrode line and connected to a first end side of the three-phase open winding, a second inverter unit connected to the positive electrode line and the negative electrode line on a side farther from the battery system than the first inverter unit and connected to a second end side of the three-phase open winding, and a first changeover switch and a second changeover switch that are provided between the first inverter unit and the second inverter unit on the positive electrode line and the negative electrode line, respectively; and
a control device, wherein:
the first inverter unit includes a first upper arm and a first lower arm of each phase that are connected in series with each other with respect to the positive electrode line and the negative electrode line, with a connection point between the first upper arm and the first lower arm being connected to the first end side of the three-phase open winding for the phase, a first capacitor and a second capacitor that are connected in series with each other with respect to the positive electrode line and the negative electrode line, with a connection point between the first capacitor and the second capacitor being connected to the series line on a side that is closer to the second battery than the third relay, and an intermediate potential switch of the phase that is provided on an intermediate potential line of the phase that connects the connection point between the first upper arm and the first lower arm of the phase and the connection point between the first capacitor and the second capacitor;
the second inverter unit includes a second upper arm and a second lower arm of the phase that are connected in series with each other with respect to the positive electrode line and the negative electrode line, with a connection point between the second upper arm and the second lower arm being connected to the second end side of the three-phase open winding for the phase; and
the control device is configured to, when an open-circuit abnormality occurs in at least one of the first upper arms and the first lower arms of the respective phases, or when a short-circuit abnormality occurs in at least one of the intermediate potential switches of the respective phases, turn on the first relay and the fourth relay, turn off the second relay and the third relay, turn on the first changeover switch and the second changeover switch, turn off the first upper arms and the first lower arms of the respective phases, turn on the intermediate potential switches of the respective phases, and perform switching of the second inverter unit, to drive the motor.

3. An electrified vehicle comprising:
a battery system including a first battery in which a first positive electrode terminal is connected to a positive electrode line, a second battery in which a second negative electrode terminal is connected to a negative electrode line, a first relay provided on the positive electrode line, a second relay provided on the negative electrode line, a third relay provided on a series line that connects a first negative electrode terminal of the first battery and a second positive electrode terminal of the second battery, and a fourth relay provided on a parallel line that connects the series line on a side that is closer to the first battery than the third relay and the negative electrode line on a side that is farther from the second battery than the second relay;
a motor for traveling including a three-phase open winding;
a power conversion device including a first inverter unit connected to the positive electrode line and the negative electrode line and connected to a first end side of the three-phase open winding, a second inverter unit connected to the positive electrode line and the negative electrode line on a side farther from the battery system than the first inverter unit and connected to a second end side of the three-phase open winding, and a first changeover switch and a second changeover switch that are provided between the first inverter unit and the second inverter unit on the positive electrode line and the negative electrode line, respectively; and
a control device, wherein:
the first inverter unit includes a first upper arm and a first lower arm of each phase that are connected in series with each other with respect to the positive electrode line and the negative electrode line, with a connection point between the first upper arm and the first lower arm being connected to the first end side of the three-phase open winding for the phase, a first capacitor and a second capacitor that are connected in series with each other with respect to the positive electrode line and the negative electrode line, with a connection point between the first capacitor and the second capacitor being connected to the series line on a side that is closer to the second battery than the third relay, and an intermediate potential switch of the phase that is provided on an intermediate potential line of the phase that connects the connection point between the first upper arm and the first lower arm of the phase and the connection point between the first capacitor and the second capacitor;
the second inverter unit includes a second upper arm and a second lower arm of the phase that are connected in series with each other with respect to the positive electrode line and the negative electrode line, with a connection point between the second upper arm and the second lower arm being connected to the second end side of the three-phase open winding for the phase; and
the control device is configured to, when an open-circuit abnormality occurs in at least one of the first upper arms of the respective phases, or when a short-circuit abnormality occurs in at least one of the first lower arms of the respective phases, turn on the first relay, the second relay, and the third relay, turn off the fourth relay, turn on the first changeover switch and the second changeover switch, turn off the first upper arms of the respective phases, turn on the first lower arms of the respective phases, turn off the intermediate potential switches of the respective phases, and perform switching of the second inverter unit, to drive the motor.
